(19) United States
(12) Patent Application Publication
(10) Pub. No.: US 2002/0074705 A1
(43) Pub. Date: Jun. 20, 2002

(54) DUAL FORCE RAPID ACTION LEVER CLAMP

(76) Inventor: Frank Marusiak, Bridgewater, NJ (US)

Correspondence Address: MATHEWS, COLLINS, SHEPHERD & GOULD, PA, 100 THANET CR, SUITE 306, PRINCETON, NJ, 08540, US

(21) Appl. No.: 09/737,401

(22) Filed: Dec. 15, 2000

Related U.S. Application Data
(60) Provisional application No. 60/171,045, filed on Dec. 16, 1999.

(51) Int. Cl. B25B 1/00

(52) U.S. Cl. 269/156

(57) ABSTRACT

A dual force rapid action lever clamp provides clamping forces essentially perpendicular to each other for accurate alignment of face frame stiles of adjacent cabinet units. The clamps are used to tightly draw together stiles of adjacent cabinets while at the same time providing pressure at the front of the stiles resulting in a tight and flush installation of the cabinets. While in a clamped position holes can be drilled and countersunk and installation screws can be driven through a drill guide hole assembly which is built into one jaw of the clamp. A short, quick, one-handed motion enables immediate adjustment and application of this clamp.

### CROSS REFERENCES TO RELATED APPLICATIONS

This application claims the benefit of U.S. Provisional application Serial No. 60/171,045, filed on Dec. 16, 1999.

### FIELD OF THE INVENTION

The invention relates to the clamps and more particularly to hand motion lever clamps.

### BACKGROUND OF THE INVENTION

In cabinet making, in order to achieve a tight and flush fit of face-frame cabinets with stiles, workers typically use hand-screw clamps, bar clamps, or c-clamps. These types of clamps offer only limited benefits when used for this purpose as they provide pressure in only one direction. While these particular clamps can tightly draw together cabinet stiles they lack a means for applying perpendicular pressure required to obtain and to maintain a flush fit. U.S. Pat. No. 5,697,601 entitled Two-Way Dual Action Clamps, provides a means for applying perpendicular pressure as required when installing face-frame cabinets. However, such dual-action clamps typically require that the user adjust two separate lead screws in order to apply the clamp, which can be slow and cumbersome. Therefore, the use of such dual-action clamps require the use of not only two hands but typically the use of an assistant to hold the cabinet in place while the clamp is being applied and adjusted.

Therefore, there is a need for a hand motion clamp that can be applied and rapidly adjusted with one hand, leaving the other hand free to support the cabinet.

### SUMMARY OF THE INVENTION

In one aspect, the present invention features a lever clamp, which applies pressure in two directions perpendicular to each other. The lever clamp can be applied and adjusted with a single motion.

### BRIEF DESCRIPTION OF DRAWINGS

The advantages, nature and various additional features of the invention will appear more fully upon consideration of the illustrative embodiments described in connection with the accompanying drawings. In the drawings:

FIG. 1 shows an elevational view showing the lever clamp with the jaws in a closed position and stiles (shown in a horizontal plane) between the jaws;

FIG. 2 shows a cross-section of FIG. 1;

FIG. 3 shows the lever clamp as it would appear during use, with the handle horizontal and the stiles vertical;

FIG. 4 shows the lever clamp shown in FIG. 3 as typically would be held within a worker's hand;

FIGS. 5 & 6 show a cross-section detail of drill guide mechanism of the lever clamp;

FIG. 7 shows a perspective view of the stile jaw with integral gear rack and the drill guide; and,

FIG. 8 shows a perspective view of the stile jaw detailing serrated jaw locking mechanism.

### DETAILED DESCRIPTION OF VARIOUS ILLUSTRATIVE EMBODIMENTS

Although the present invention is particularly well suited for use in cabinetry making, and shall be so described, the present invention is equally well suited for uses in other applications, which require similar clamping forces.

In one aspect, the present invention features a dual force rapid action lever clamp, which provides clamping forces perpendicular to each other. In one exemplary embodiment of the present invention, dual force rapid action lever clamp enables the accurate alignment of face frame stiles of adjacent cabinet units. The dual force rapid action lever clamps are used to tightly draw together stiles of adjacent cabinets while at the same time providing pressure at the front of the stiles resulting in a tight and flush installation of the cabinets. While in a clamped position holes can be drilled and countersunk and installation screws can be driven through a drill guide hole assembly which is built into one jaw of the clamp. In this exemplary embodiment of the dual force rapid action lever clamp, each clamp has two L-shaped jaws with integral gear racks, which mesh with a central drive gear and shaft assembly, the drive assembly and jaws are maintained in proper relationship between top and bottom assembly plates. A shaft extends transversely through a bore in the drive gear/ shaft and assembly plates and connects to a pressure plate. While turning a lever, which is connected to the drive gear, the jaws will close bringing the stiles into a snug position, then a slight inward hand force is applied to the lever/handle by the user. As a result of leverage a greater compounded pressure will be transferred to the shaft and pressure-plate pushing the front faces of the stiles into a flush position. Rotating the handle a few more degrees will bring the stiles into a final tight and flush relationship. Therefore, a short, quick, one-handed motion will provide immediate adjustment and application of the dual force rapid action lever clamp to the work material.

When using the dual force rapid action lever clamps of the present invention a worker can apply and adjust the dual force rapid action lever clamp with one hand, leaving the other hand free to support the cabinet. The rapid adjustment of the dual force rapid action lever clamp is such that in this embodiment only a quarter turn and slight inward push on the lever is necessary to achieve a tight and flush installation of cabinets.

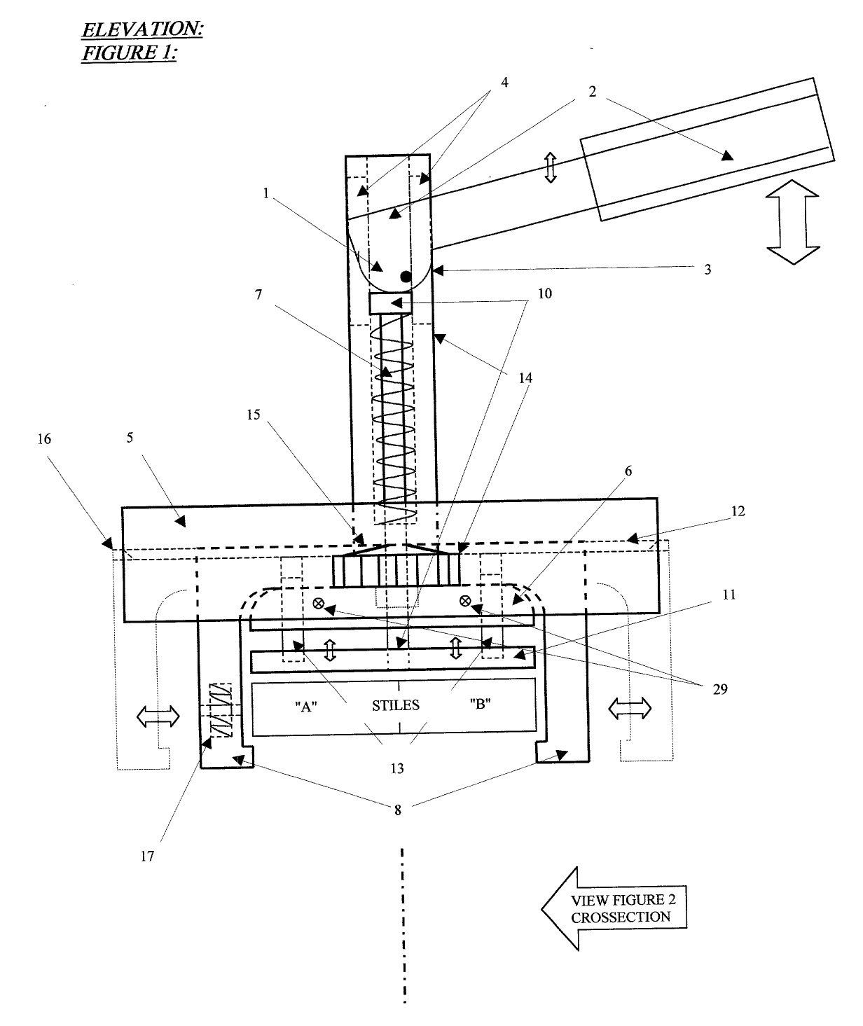

Referring to FIG. 1, there can be seen an elevational view showing the lever clamp with the jaws in a closed position and stiles (shown in a horizontal plane) between the jaws. Cabinet stiles A & B are shown between stile jaws 8. A lever/handle 2 may be attached to the drive gear and shaft assembly 14 by a rollpin which functions as fulcrum 1 which provides a pivot point for inward motion of the lever/handle 2. The pivot end of lever/handle 2 is flatter and thinner than the handle end of lever/handle 2 allowing it to pass through vertical slots 4 which bisect the upper end of the shaft section of drive gear and shaft assembly 14. As lever/handle 2 is turned the drive gear and shaft assembly 14 will rotate and its gear teeth will simutaneously engage the gear rack 9 of both stile jaws 8. Engagement of the drive gear and shaft assembly 14 and gear rack 9 will cause each stile jaw(s) 8 to travel in a parallel relationship upon parallel jaw guide rails 12 which travel within mating grooves 16 provided within each stile jaw(s) 8. One stile jaw(s) 8 will travel towards the right and one stile jaw(s) 8 will travel to the left. Therefore, when lever/handle 2 is turned each stile jaw(s) 8 will travel to an open or closed position depending upon which direction the lever/handle 2 is turned. Since stile widths vary the degree of turn upon lever/handle 2 will also vary, as required to provide proper adjustment for different width stiles. When stile jaws 8 travel to the closed position stiles A & B will be brought into a snug relationship. At this point, inward hand pressure is applied to the lever/handle 2 and it will pivot about fulcrum 1 and cause the cam 3 of lever/handle 2 to contact pressure plate plunger 10 forcing it towards stile A & B. Because fulcrum 1 is eccentric within the cam 3 it will cause the distance between fulcrum 1 and pressure plate plunger 10 to increase as lever/handle 2 is pushed inward, this eccentric relationship between fulcrum 1 and cam 3 will also maintain pressure upon the pressure plate 11 until lever/handle 2 is lifted to the open position. As pressure plate plunger 10 forces pressure plate 11 inward a greater pressure, due to leverage, will force stiles A & B to be pushed into a flush relationship. Once this flush stile position is achieved another slight turn of the lever/handle 2 will bring stiles A & B into a final tight and flush position. Full opening and closing motion of stile jaws 8 may be achieved with an approximate ¼ turn of lever/handle 2. When in the closed position the stile jaws 8 will maintain pressure upon the stiles because disk spring washer 15, which may be serrated or of split lock-washer design, will become compressed between the top of the drive gear 14 and the bottom of the top assembly channel 5 preventing the drive gear and shaft assembly 14 from rotating back towards the open position. Disk spring washer 15 will become compressed because the drive gear and shaft assembly 14 will be forced slightly upward between assembly channel 5 and bottom assembly plate 6 as lever/handle 2 is pushed inward against pressure plate plunger 10.

As can be seen in FIG. 1, the entire drive mechanism is held in proper relationship between assembly channel 5 and bottom assembly plate 6 which maybe connected by screws 29. Pressure plate guide pins 13 which are connected to pressure plate 11 will travel in holes which maybe drilled through bottom assembly plate 6. The pressure plate 11 is connected to the pressure plate plunger 10 which travels in a bore within the drive gear and shaft assembly 14 and is maintained in the normal open position by pressure plate spring 7. Pressure plate plunger 10 may also serve as a pivot point for rotation of the drive gear and shaft assembly 14 as it passes through a hole in the bottom assembly plate 6, the shaft section of drive gear and shaft assembly 14 serves as the top pivot point as it passes through a hole in the top assembly channel 5. Drill guide hole/assembly 17 will be described in seperate detail below.

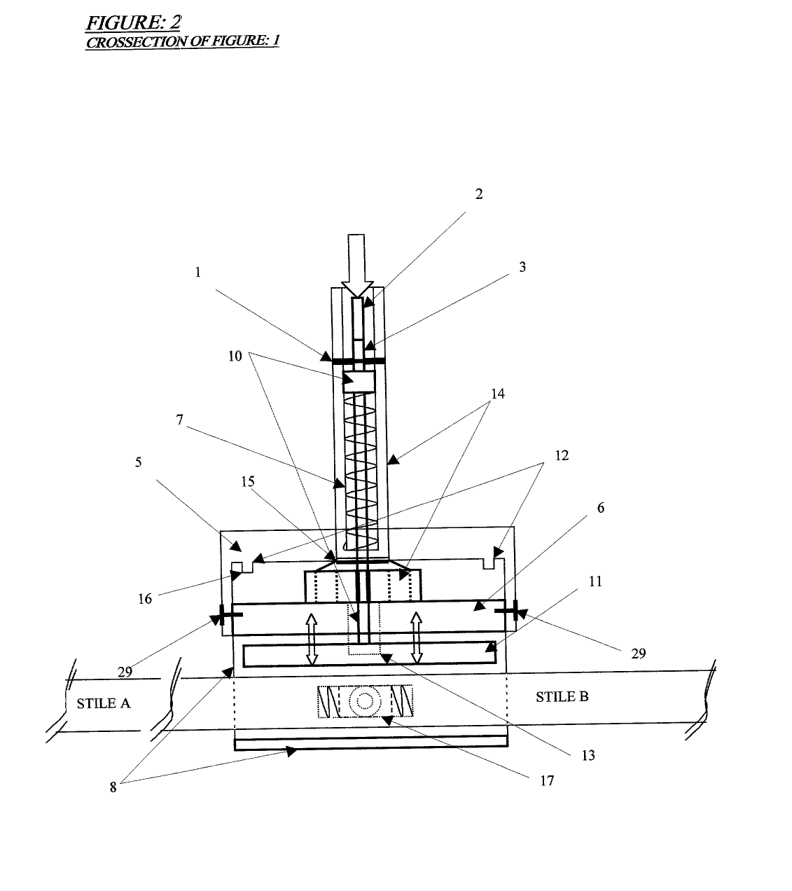

Referring to FIG. 2 there can be seen a cross-section of the present invention, dual force rapid action lever clamp seen in FIG. 1. Similar elements are numbered the same as in the previous figure.

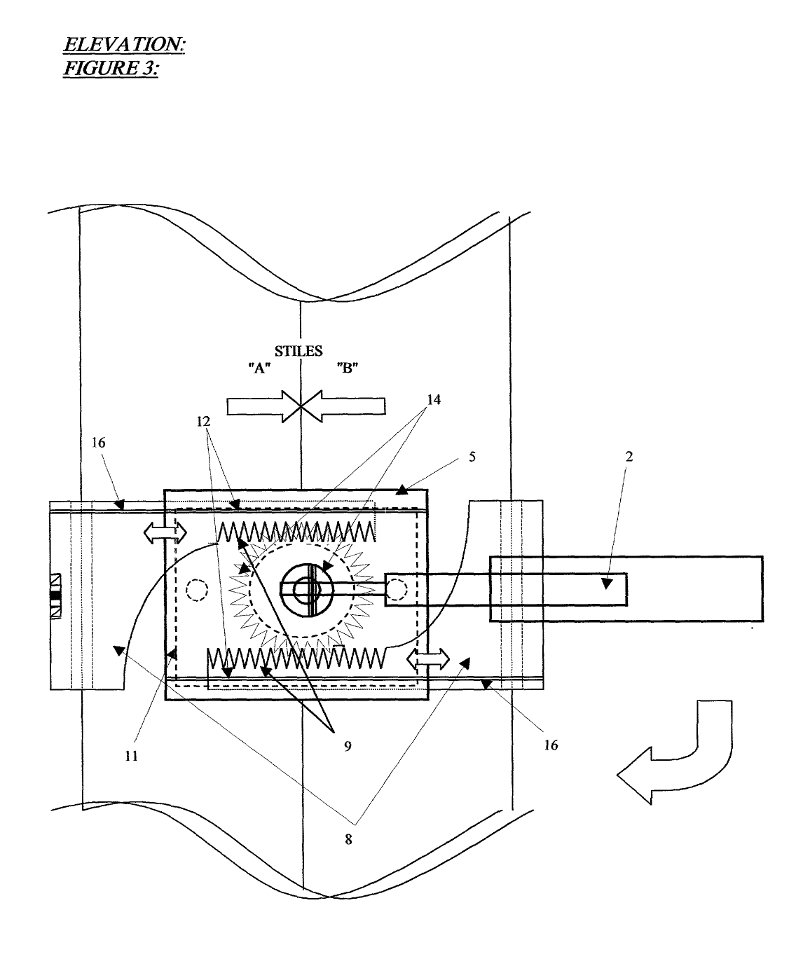

Referring to FIG. 3 there can be seen the present invention, dual force rapid action lever clamp, as it would appear during use, with the handle horizontal and the stiles vertical. Similar elements are numbered the same as in the previous figures. The dual force rapid action lever clamp is applied with the stiles A & B between stile jaws 8 and with pressure plate 11 in flat contact with the front of stiles A & B. As the lever/handle 2 is turned downward in a clockwise direction, the drive gear and shaft assembly 14 will rotate. The gear teeth of drive gear and shaft assembly 14 mesh with the rack teeth 9 of the stile jaws 8, causing each stile jaw 8 to travel in opposite directions, inwards towards the drive gear and shaft assembly 14 when closing the clamp and away from drive gear and shaft assembly 14 when opening the clamp. The stile jaws 8 travel in an straight and parallel manner upon parallel jaw guide rails 12 as they travel through a mating groove 16 which is provided in stile jaws 8. The stile jaws 8 and drive gear and shaft assembly 14 are properly maintained between top assembly channel 5 and bottom assembly plate 6 (not shown). The shaft section of drive gear and shaft assembly 14 passes through a hole in the top assembly channel 5, the drive gear and shaft assembly 14 will rotate within this hole pivoting upon the shaft section of drive gear and shaft assembly 14.

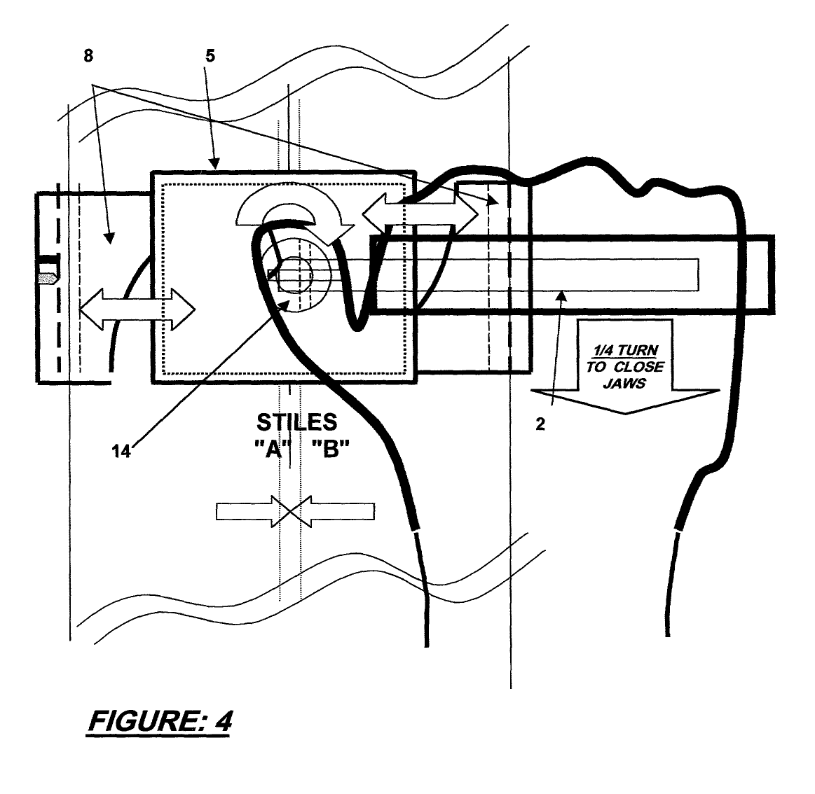

Referring to FIG. 4 there can be seen the lever clamp shown in FIG. 3 as typically would be held within a worker's hand and applied. Similar elements are numbered the same as in the previous figures. In an approximate level position with the lever/handle 2 perpendicular to the stiles A & B, the worker's hand should wrap around the ergonomically designed lever/handle 2, with the thumb naturally positioned below or about the drive gear and shaft assembly 14. In this position the lightweight clamp is comfortably supported and balanced. With stile jaws 8 in the open most position lever/handle 2 will be at 3 o'clock position. To apply the clamp, pressure plate 11 is brought into light flat contact with the front of the cabinet stiles A & B with stiles A & B between stile jaws 8. Once in this position the lever/handle 2 is turned downward, in a clockwise rotation, approximately ¼ turn (the actual amount of the rotation may be more or less depending on the width of the stiles) to the 6 o'clock position, applying sufficient pressure to just bring the stiles A & B into snug contact with each other. When snug the lever/handle 2 is pushed inward applying greater pressure, due to leverage, to the front faces of the stiles A & B forcing them into a flush relationship. Finally, the lever/handle 2 is turned slightly clockwise (another degree or two) bringing the stiles A & B into a final tight and flush relationship. The rapid action of the stile jaws 8 and pressure plate 11 enables the entire application to be completed in only seconds. To remove the clamp pull the lever/handle 2 disengaging the pressure plate 11 and then raise the lever/handle counterclockwise back up to 3 o'clock.

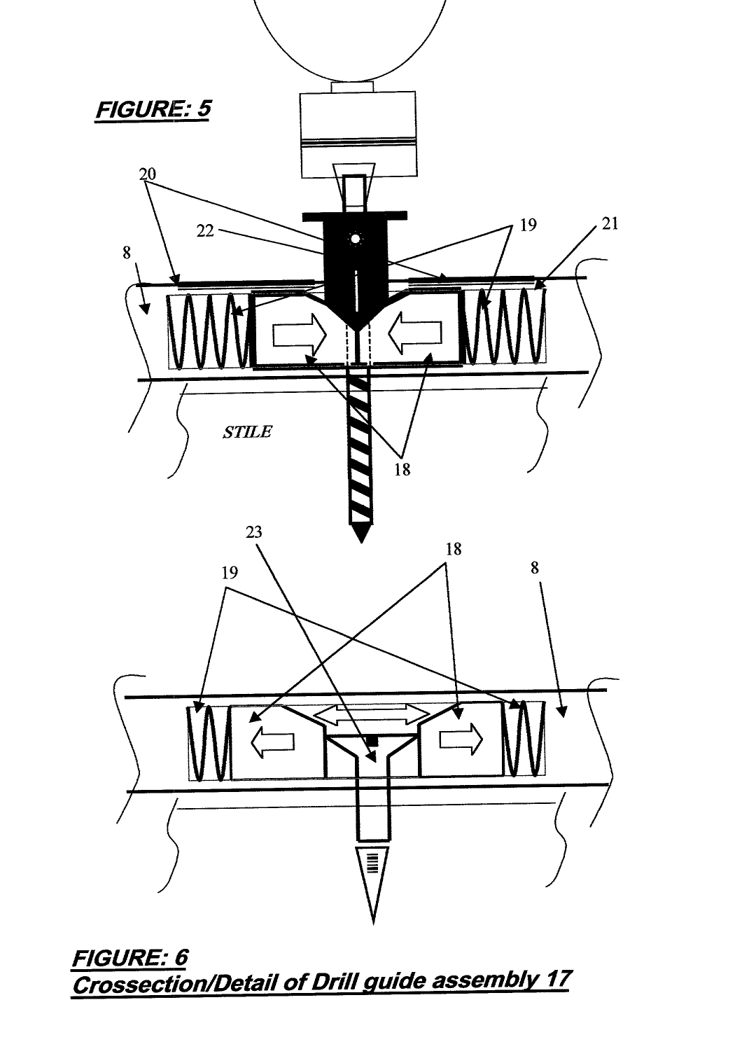

Referring to FIGS. 5 and 6 there is shown show a cross-section detail of drill guide assembly 17 of the lever clamp. Similar elements are numbered the same as in the previous figures. The drill guide assembly 17 is passive. Entry of a drill and countersink bit 22 or the fastening screw 23 automatically results in all required movement of parts. FIG. 5 shows hardened drill guide halves 18 held in a normally closed position biased by drill guide springs 19. The hardened drill guide halves 18 and the drill guide springs 19 are maintained within a hollowed recess 21 provided within the stile jaws 8 and may be held in place with retaining rings 20 or other suitable elements. When closed the two halves of the hardened drill guide halves 18 form a drill guide hole for a drill bit, such as an ⅛″ diameter drill bit. The closed halves of the hardened drill guide halves 18 also form a female wedge shaped cylinder into which the countersink section of the drill and countersink bit 22 will mate. As the drill and countersink bit 22 enter and advance through the hole formed by the hardened drill guide halves 18 the wedge shape of the countersink section of drill and countersink bit 22 will cause the two halves of the hardened drill guide halves 17 to spread apart as shown in FIG. 6, permitting the larger countersink section of drill and countersink bit 22, and a screw 23 as shown in FIG. 6 to advance into the stile. Removal of the drill and countersink bit 22 cause the hardened drill guide halves 18 to return to the normally closed position, pushed back into position by the drill guide springs 19.

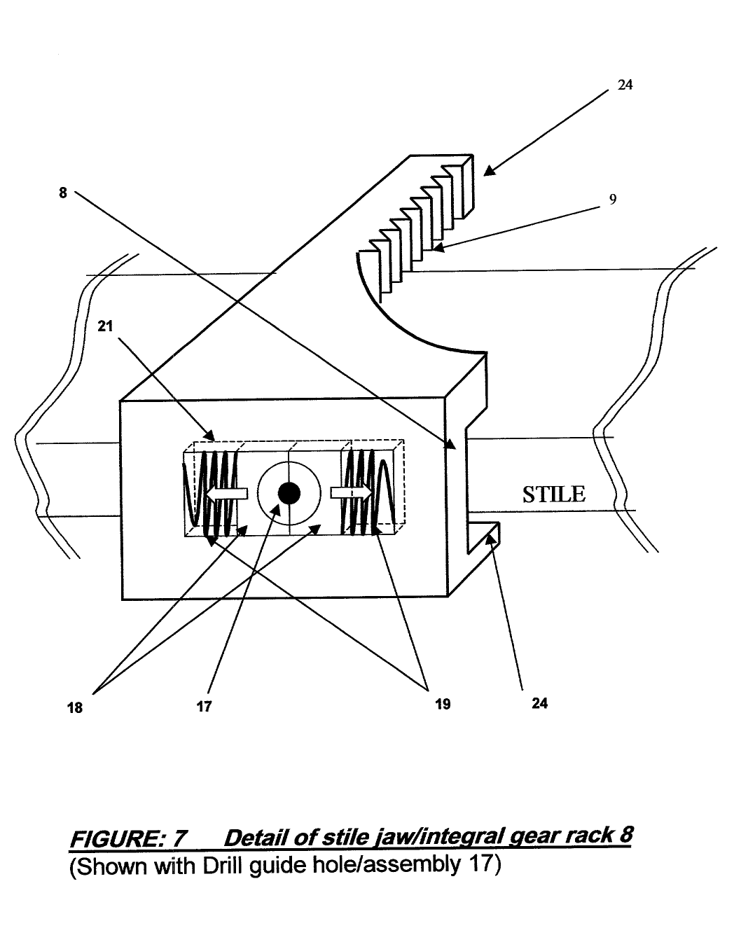

Referring to FIG. 7, there is shown a perspective view of the stile jaw with integral gear rack and the drill guide. Similar elements are numbered the same as in the previous figures. The stile jaws 8 are shown with return flange 24 hooked around the backside of a cabinet stile. A hollowed recess 21 may be provided within the stile jaws 8. The hollowed recess 21 provides a housing area for the hardened drill guide halves 18 and drill guide springs 19, which form the drill guide mechanism. This drill guide mechanism is held with a retaining ring 20 within the hollowed recess 21. A stop tooth 24 is provided at the end of the gear rack 9 to limit the travel of the stile jaws 8.

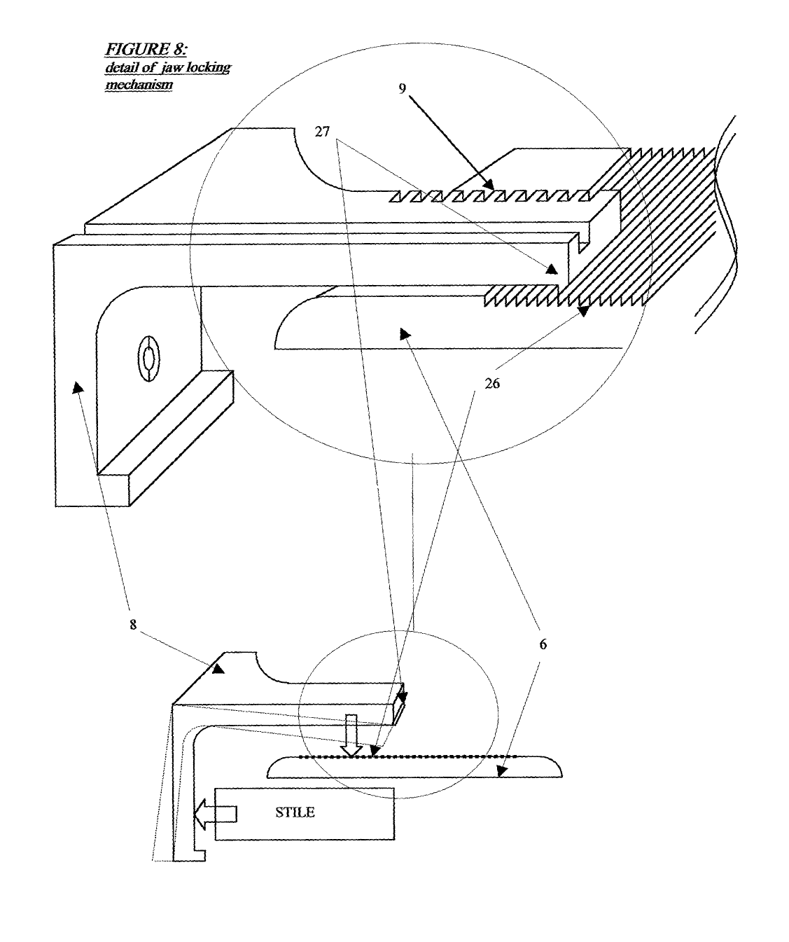

Referring to FIG. 8 there is shown a perspective view of the stile jaw detailing serrated jaw locking mechanism, which is another embodiment of an additional method for preventing the stile jaws 8 from opening while under pressure. Similar elements are numbered the same as in the previous figures. The close-up perspective view of the stile jaws 8 details one embodiment of the locking mechanism, which prevents the stile jaws 8 from backing off while under pressure. As pressure is applied to the stile by stile jaws 8 the gear rack portion 9 of the stile jaws 8 will rock and tilt slightly towards bottom assembly plate 6 as it travels between bottom assembly plate 6 and top assembly channel 5 causing a raised tooth 27 to engage and lock within slight serration 26 provided within the bottom assembly plate 6. As clamping pressure is relieved upon opening of the clamp the tooth 27 will disengage from within the serration 26 allowing the stile jaws 8 to move freely back to the opened position.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claim, is reserved.

What is claimed:

1. A dual action lever clamp hand tool comprising:
a lever arm;
a pressure plate coupled to said lever arm;
at least two clamping jaws coupled to said lever arm;
wherein movement of said lever arm enables said pressure plate to apply a first force and said clamping jaws to apply a second force, said first force being substantially perpendicular to said second force.

2. The dual action lever clamp hand tool as recited in claim 1 wherein movement of said lever arm in an angular movement.

3. The dual action lever clamp hand tool as recited in claim 2 wherein said angular movement is less than 180 degrees.

4. The dual action lever clamp hand tool as recited in claim 2 wherein said angular movement is approximately 90 degrees.

5. The dual action lever clamp hand tool as recited in claim 1 wherein one clamping jaw has a guide hole for drilling.

6. The dual action lever clamp hand tool as recited in claim 1 wherein said at least two clamping jaws are coupled to a gear rack and a corresponding pinion such that movement of said lever arm enables movement of said corresponding pinion which enables movement of said gear rack which enables movement of said at least two clamping jaws to apply said second force.

7. The dual action lever clamp hand tool as recited in claim 5 wherein said guide hole for drilling expands for passage of a fastener.

8. The dual action lever clamp hand tool as recited in claim 7 wherein said guide hole is biased in an unexpanded position by at least one spring.

9. The dual action lever clamp hand tool as recited in claim 1 wherein said at least two clamping jaws further comprise a locking mechanism.

10. A single motion dual action clamp hand tool comprising:
a lever arm;
a pressure plate coupled to said lever arm;
at least two clamping jaws coupled to said lever arm;
wherein single motion movement of said lever arm enables said pressure plate to apply a first force and said clamping jaws to simultaneously apply a second force, said first force being substantially perpendicular to said second force.

11. The single motion dual action clamp hand tool as recited in claim 10 wherein single motion movement of said lever arm in an angular movement.

12. The single motion dual action clamp hand tool as recited in claim 11 wherein said angular movement is less than 180 degrees.

13. The single motion dual action clamp hand tool as recited in claim 11 wherein said angular movement is approximately 90 degrees.

14. The single motion dual action clamp hand tool as recited in claim 10 wherein one clamping jaw has a guide hole for drilling.

15. The single motion dual action clamp hand tool as recited in claim 10 wherein said at least two clamping jaws are coupled to a gear rack and a corresponding pinion such that movement of said lever arm enables movement of said corresponding pinion which enables movement of said gear rack which enables movement of said at least two clamping jaws to apply said second force.

16. The single motion dual action clamp hand tool as recited in claim 14 wherein said guide hole for drilling expands for passage of a fastener.

17. The single motion dual action clamp hand tool as recited in claim 16 wherein said guide hole is biased in an unexpanded position by at least one spring.

18. The single motion dual action clamp hand tool as recited in claim 10 wherein said at least two clamping jaws further comprise a locking mechanism.

19. A rapid motion dual force clamp hand tool comprising:
a lever arm having a range of functional angular motion of less than 180 degrees;
a pressure plate coupled to said lever arm;
at least two clamping jaws coupled to said lever arm;
wherein single angular movement of said lever arm enables said pressure plate to apply a first force and said clamping jaws to apply a second force, said first force being substantially perpendicular to said second force.

20. The rapid motion dual force clamp hand tool as recited in claim 19 wherein said at least two clamping jaws are coupled to a gear rack and a corresponding pinion such that the single angular movement of said lever arm enables movement of said corresponding pinion which enables movement of said gear rack which enables movement of said at least two clamping jaws to apply said second force.
